(19) United States
(12) Patent Application Publication
(10) Pub. No.: US 2005/0064821 A1
(43) Pub. Date: Mar. 24, 2005

(54) Alternative service management

(75) Inventors: Tomas Hedberg, Stockholm (SE); Bo Burman, Upplands Vasby (SE)

Correspondence Address: NIXON & VANDERHYE, PC, 1100 N GLEBE ROAD, 8TH FLOOR, ARLINGTON, VA, 22201-4714, US

(73) Assignee: Telefonaktiebolaget LM Ericsson (publ), Stockholm (SE)

(21) Appl. No.: 10/895,990

(22) Filed: Jul. 22, 2004

Related U.S. Application Data
(60) Provisional application No. 60/503,888, filed on Sep. 22, 2003.
(60) Provisional application No. 60/585,521, filed on Jul. 6, 2004.

(51) Int. Cl. H04Q 7/20

(52) U.S. Cl. 455/67.11

(57) ABSTRACT

The invention provides management of alternative services in a communications system (1). A user equipment (300) requests a primary service at the communications network (10) during the setup of a communications session. In addition, at least one possible alternative service to use if the primary service is unavailable is suggested. Radio performance and signaling quality of the bearers of the primary and alternative service(s) are monitored. If the quality deteriorates, the network (10) issues a service change to a less quality demanding alternative service. If the quality subsequently improves, the network (10) can issue a fallback reversion, thus, changing service to a more preferred service, typically the requested primary service.

### RELATED APPLICATIONS

The present regular utility patent application claims priority of U.S. provisional patent application No. 60/503,888, filed Sep. 22, 2003.

### TECHNICAL FIELD

The present invention generally refers to communications services in communications systems, and in particular to management of alternative communications services in such systems.

### BACKGROUND

In mobile communications systems of today several new and enhanced services are emerging as a complement to the traditional speech and voice services. For example, third generation mobile communications systems, such as UMTS (Universal Mobile Telecommunications System), will support video telephone and other similar multimedia services in addition to supporting voice services. For such an UMTS system, it has been proposed to use a “fallback” service in addition to the video telephony.

According to a 3GPP TS document [1], during call set-up an originating mobile user equipment can send a message to its associated originating MSC (Mobile Switching Center), indicating that it would like to conduct a video telephony call. In addition, in this message the user equipment can also list one possible, less preferred, call service, such as traditional voice call, to use if the preferred video telephony is unavailable. This originating MSC then negotiates currently possible services and radio access bearers with a terminating MSC, to which a terminating mobile user equipment, with which the originating user equipment wants to conduct the video call, is connected. This terminating user equipment can then accept the video call, or if it does not support such an enhanced service otherwise does not want to conduct such a video service, reject the call. In the former case, the video telephony call is performed, whereas in the last case the (fallback) voice call is performed instead.

In addition, during the communications session the end-users can select and toggle between video call and traditional voice call. For example, the session between the originating user and the terminating user can be set-up and started as a traditional voice call. However, during the current active call mode one of the user can indicate, through his/her user equipment, that the voice call should be turned into a video telephony call by activating an in-call modification procedure, preferably without dropping the call or session. In such a case, the service is changed during the call.

The user-initiated change in service proposed in [1] has some major drawbacks. For example, the user might want to change from a fallback service to a more demanding (at least for the network) video telephony service at an unsuitable time, e.g. when no radio bearer or channel supporting this multimedia service is available. In addition, the channel quality of the bearer/channel supporting one of the services might suddenly deteriorate, resulting in a drop of the call session before the user is able to initiate a service change. As a consequence, the prior art solution is inflexible.

### SUMMARY

The present invention overcomes these and other drawbacks of the prior art arrangements.

It is a general object of the present invention to provide management of alternative services in a communications system.

It is another object of the invention to provide network-initiated change of alternative services in such a communications system.

It is a further object of the invention to provide a service change management responsive to communications quality information.

These and other objects are met by the invention as defined by the accompanying patent claims.

Briefly, the present invention involves management of alternative services in communications systems. According to the invention, a user equipment or other communicating unit informs its connected network, typically core network portion of the network, of a requested primary service it would like to use for a communications session with another user equipment or communicating unit. This service information is typically included in a setup message transmitted to the MSC (Mobile Switching Center) of the core network. Furthermore, the user equipment also preferably includes information of one or multiple possible alternative or fallback services to use if the preferred primary service is unavailable, e.g. due to current radio performance and quality conditions, functionality of the user equipment it wants to communicate with, etc. This alternative service information could as an alternative be provided from another source, e.g. suggested by the other user equipment, from a pre-defined user service profile stored in the network and including information of suitable alternative services, or from a default list of possible alternative services available in the network.

The network then preferably stores this information of the requested primary service and the alternative service(s). It then investigates if the requested, most preferred, service is available or not. In either case a suitable channel or radio access bearer is assigned, on which the selected service conducted. The network also preferably stores information of the service currently used.

During the ongoing communications session, communications quality data is estimated that represent the signal quality and radio performance of the used bearer and service and/or of the other bearers or channels for the other services presently not used. This quality data can be estimated based on quality estimations performed by the participating user equipments and/or the relevant communicating network nodes, e.g. base station(s).

The communications network will then use this quality data for determining whether a service change to another communications service should or may be initiated. For example, if the signal quality deteriorates and drops below a threshold value, the network might not be able to provide the current service at an adequate quality level. In such a case, the network initiates a service change, resulting in a change (downgrading) of service (and the bearer). If the current service is the primary service, an alternative service is then selected. However, if instead an alternative service is currently used, another (less quality demanding) alternative service with lower signal quality requirements could be selected. The service is then changed and a handover to a new bearer is performed where required. The user equipment can then continue its communication but now using the updated (less preferred) alternative service. Information of the updated service is preferably stored in the network.

If the radio performance and quality subsequently improve and allow use of a more preferred service, either a more preferred alternative service or, more preferably, the requested primary service, the network can issue a service upgrade. Similarly to above, the service is changed and a possible handover to a new bearer is performed. Information of this updated service is preferably stored in the network. The communications is then continued with this upgraded service.

In order to speed up a possible reestablishment back to an already employed communications service, when performing a service change the respective user equipment preferably put the current communications application on hold before initiating the new application, similar to as if there is a (long) link disturbance. In addition, the negotiated context for this service is maintained or stored in the equipment before using the new one. Thus, if a subsequent service change back to this service is performed during the communications session, the held communications application is resumed using the previously negotiated and kept context. This will allow a much faster, service re-establishment than if the context would have to be anew negotiated between the user equipments and the network. This is especially advantageous for certain communications services and applications having long round trip times and session establishment times, e.g. video telephony. Alternatively, a pre-defined (simple) default configuration is used by the user equipment for starting the service change. Thereafter, the user equipment switches to a configuration associated with the new communications service. The default configuration should then be simpler than the corresponding ordinary service configuration in order to speed up the service change.

The primary service according to the invention is typically an enhanced service, whereas the alternative services are more traditional communications services and are, typically, less demanding for the communications network and typically have lower requirements on signal quality. For example, a typical enhanced service could be a multimedia service, including UDI (Unrestricted Digital Information)/RDI (Restricted Digital Information) multimedia service, video telephony call service, push-to-talk service. The alternative service can in these cases be a traditional speech service. Furthermore, if the enhanced service is a streaming service, providing data packets in “real-time” to a communications unit, a typical fallback service is a regular data download service, i.e. not in “real-time”.

The invention offers the following advantages:
Provides flexible change of alternative services for communicating units;
Allows scheduling of service changes to situations where the quality conditions and bearer availability allow such changes;
Provides better quality for end users; and
Simplifies use of “enhanced” services and service calls.

Other advantages offered by the present invention will be appreciated upon reading of the below description of the embodiments of the invention.

### SHORT DESCRIPTION OF THE DRAWINGS

The invention together with further objects and advantages thereof, may best be understood by making reference to the following description taken together with the accompanying drawings, in which:

FIG. 1 is a schematic overview of a portion of a communications system, to which the teachings of the present invention can be applied;

FIG. 2 is a flow diagram illustrating an embodiment of a service management method according to the present invention;

FIG. 3 is a flow diagram illustrating additional steps of the management method of FIG. 2;

FIG. 4 is a flow diagram illustrating an embodiment the initiating step of the management method of FIG. 2;

FIG. 5 is a flow diagram illustrating another embodiment the initiating step of the management method of FIG. 2;

FIG. 6 is a schematic signal diagram illustrating an embodiment of the service management method according to the present invention;

FIG. 7A is a schematic signal diagram illustrating a more detailed example of the signal diagram of FIG. 6;

FIG. 7B is an example of a continuation of the signaling example of FIG. 7A;

FIG. 8 is another example of a continuation of the signaling example of FIG. 7A;

FIG. 9 is a schematic block diagram illustrating an embodiment of a communications network according to the present invention;

FIG. 10 is a schematic block diagram illustrating an embodiment of the service manager of FIG. 9; and

FIG. 11 is a schematic block diagram illustrating an embodiment of the quality comparator of FIG. 10.

### DETAILED DESCRIPTION

Throughout the drawings, the same reference characters will be used for corresponding or similar elements.

The present invention relates to service management in communications systems and in particular to management of alternative services in such systems. According to the invention, when initiating a communications session between communicating units in the communications system, a communicating unit requests a primary communications service to use for that session. In addition, at least one alternative, “fallback or equivalent” service is identified for usage if the primary service is unavailable. This unavailability can be due to that one of the units participating in the session does not support the primary service and/or that a user of a unit does not want to conduct communication with this primary service. Alternatively, or in addition, the communications system, in which one of the communicating units currently is present, might not support this service.

In either case, the communications session is started with the primary service or an alternative service. During the communications session, the communicating units and/or base station(s), to which they are connected, perform signal or communications quality measurements for the current communications service and its associated radio channel/link or radio bearer (RB). In addition, the base station(s) may also, or instead, perform quality estimations of radio channels for the currently non-employed services, selected from the primary and the at least one alternative service.

If the radio conditions change, as determined based on quality measurements, the communications network may initiate a service change from the current communications service to one of the currently non-employed services. The communication between the communicating units will then be conducted using this new service. Thus, an in-call service modification procedure is triggered and conducted by the network, preferably without dropping the call or session.

For example, if the communications quality of the current RB deteriorates so that the network will no longer be able to provide the current communications service at adequate quality levels, the network will trigger a service (downgrade) change to an alternative service with less stringent quality requirements. Furthermore, in cases where the radio performance and communications quality increases, a service (upgrade) change to a more preferred communications service (unless already employing the most preferred service) may be initiated by the network based on the estimated communications quality.

Thus, since the network initiates and determines when to perform a services change it can schedule such a change based on quality data and availability of suitable RABs and radio channels. This is in clear contrast to prior art techniques, where such a service change is triggered by a user of a user equipment unit without any knowledge of or concern about the current radio performance in the system or availability of radio channels for the new updated communications service.

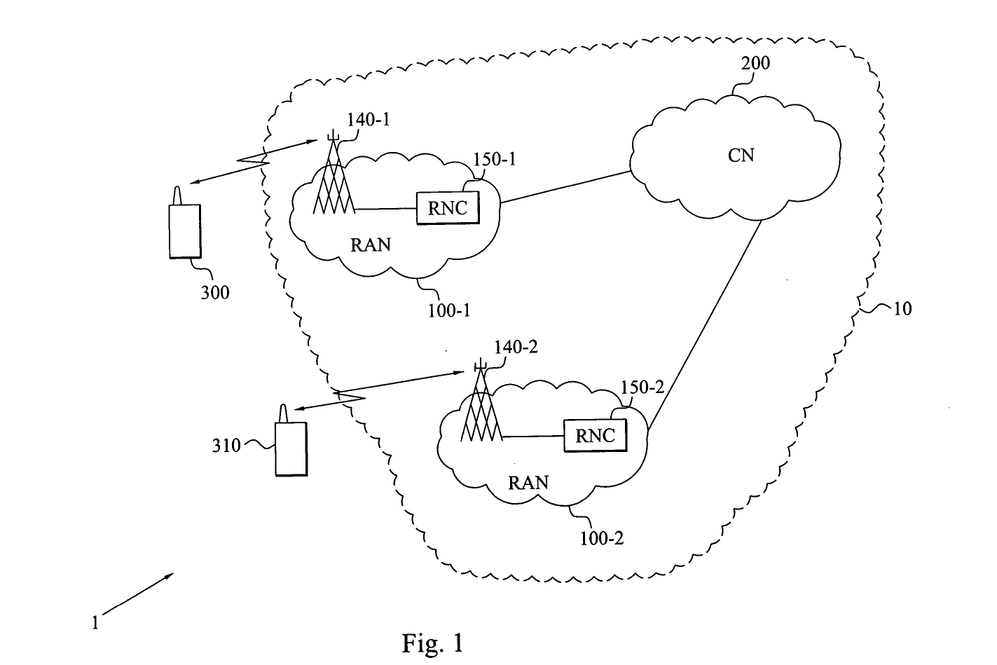

FIG. 1 is a schematic overview of a portion of a communications system 1, to which the teachings of the present invention can be applied. The system 1 could be a radio communications system, e.g. a Global System for Mobile communications (GSM) system, General Packet Radio Service (GPRS) system, Enhanced GPRS (EGPRS) system, Enhanced Data rates for GSM Evolution (EDGE) based system, Universal Mobile Telecommunications System (UMTS) system and different Code Division Multiple Access (CDMA) communications systems.

Generally, the communications system includes a communications network 10 that provides communications services to connected communicating units 300, 310 that could be (mobile) user equipment, mobile units, mobile telephones, Personal Digital Assistants (PDAs) or communicating computers or servers. Generally, especially for a radio communications system 1, the network 10 can be organized into core network (CN) portions 200, of which only one is illustrated in FIG. 1 in order to simplify the figure, with connected radio access network (RAN) portions 100-1, 100-2. As is known in the art, the RAN portions 100-1, 100-2 in turn includes base stations 140-1, 140-2 that performs the direct communication with the user equipment 300, 310. In addition, a radio network controller (RNC) 150-1, 150-2, base station controller (BSC) or other controlling unit can be arranged in the RAN for controlling the operation of the base stations 140-1, 140-2.

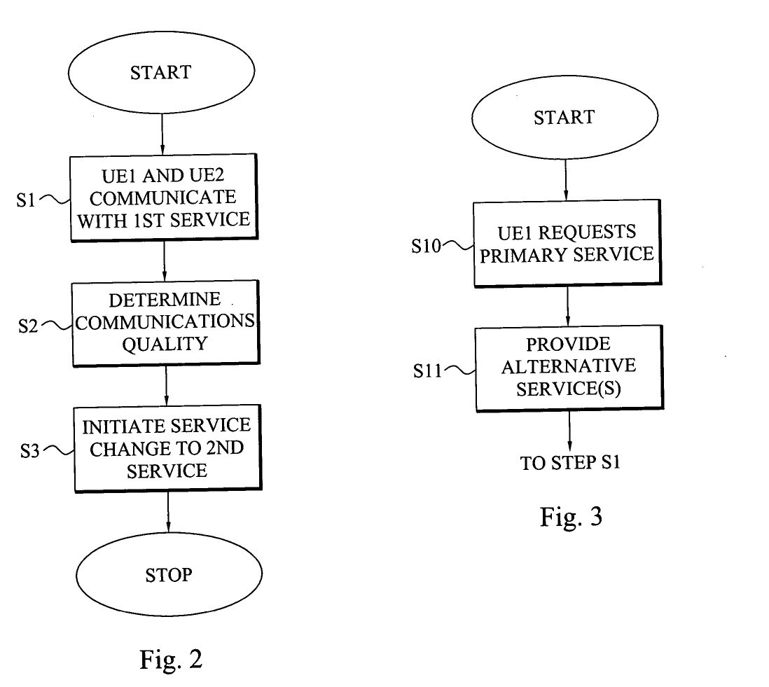

FIG. 2 is a flow diagram illustrating an embodiment of the communications service management method according to the present invention. In the discussion below in connection with FIG. 2, it is assumed that a primary communications service has been requested by a first user equipment or communicating unit. In addition one alternative communications service has been notified for usage if the primary service is unavailable. This should, however, merely been seen as an illustrative example and the invention can, as will be described in more detail below, also be applied to situations where multiple, i.e. at least two, alternative services are suggested.

The method starts in S1 where the first and second user equipment communicate using a first communications service. This first service is selected from the primary and the alternative service. The first service may, for example, have been negotiated between the first and second user equipment and the communications network during session setup. During this communications session, communications quality data is determined or estimated in a next step S2.

In an embodiment of the invention, the first user equipment and/or the second user equipment perform these quality measurements. In such a case, quality data for the employed downlink channels may be estimated. This quality data is then forwarded from the user equipment to the communications network, where it is processed in order to determine whether to initiate a service change.

In another embodiment of the invention, the base station(s), to which the user equipments are connected, perform the quality estimations for the radio channels with the user equipments. Thus, in this embodiment uplink-based quality data is estimated by the network and used in the service change determining procedure. Alternatively, or preferably in addition, the communications network performs quality estimations for the RB and radio channel that could be used for the second currently non-employed communications service. This means that quality data also for this second service may be obtained and used in the determining procedure. This communications quality for the second service may be obtained from quality measurements and/or be estimated based on the quality measurements performed for the first service. By also using quality data for the second service, the network can elucidate whether the current conditions really are good enough to support this service. It could be situations where the present radio conditions are so poor that neither the primary or alternative communications service will be adequately supported by the network. In such cases, it might be necessary for the network to drop the communication session. However, in cases with multiple suggested alternative service, the network might identify at least one of them that can be used even under such poor radio conditions.

The two embodiments above can also be combined so that both network-performed and user-equipment-performed quality measurements will be used in determining whether to initiate a service change.

The quality measurements by the user equipment and the base station may be performed periodically or intermittently. Alternatively, they can be triggered in response to a measurement request from a unit in the communications system.

In either case, the quality data is provided to the network, unless it had been estimated therein, for processing and determining whether to initiate a service change from the first (current) service to the second (currently non-employed) service. If such service change should be triggered, as determined based on the quality data, the communications network triggers the service change in a next step S3. The service change is preferably performed without dropping the current communications session and with as little disturbance for the involved users as possible. The communication between the first and second user equipment is then continued using this second service. The method then ends.

Note that steps S2 and S3 may be repeated during the communications session. This means that if the radio performance and RB conditions anew changes the communications system may initiate a new service change.

It is anticipated that the service change may be implemented as a service downgrade or a service upgrade. In the former case, the communications quality for the current RB and service deteriorates and falls below a downgrade threshold. This means that the present radio conditions are so poor that the communications network will not be able to provide the current service at an adequate or acceptable quality level and it might be possible that the communications session has to be dropped if no service change procedure is triggered. In these situations, the network initiates a service change to a less quality demanding service, often the alternative communication service, and a suitable radio access bearer (RAB) to use for this new service is assigned. This service downgrade allows the user equipments to continue the communication session, however, by employing the new and possibly less preferred service. Since the only other available alternative would be to drop the call, the users will yet perceive the service downgrade as a major improvement compared to dropping the session.

In addition, if the radio conditions improves, it might be possible for the network to initiate a service upgrade to a more preferred, from the users' point of view, communications service if the communications quality for this preferred service and its associated RB exceeds an upgrade threshold.

In cases where one of the user equipment, but not the other one, experience a poor radio performance, the network may be configured for performing a service downgrade (e.g. if the quality for the user equipment falls below the downgrade threshold). Thus, in such an implementation a service change is initiated based on communications quality data for the presently poorest user equipment—base station connection. This means that if the estimated quality data for this poorest connection or channel falls below the downgrade threshold, the network will initiate a service downgrade for both the user equipments. Similarly, if the poorest connection allows a service upgrade, due to the quality for its radio channel exceeds the upgrade threshold, the network triggers and performs such a service change for the user equipments.

Alternatively, the quality data for the relevant communication channels for all, or at least two, user equipment participating in the communications session may be used in determining whether to initiate a service change or update procedure. In such a case, the quality data for these channels may be weighted together, possibly using different weight for different connections, to give a resulting quality measure that is used by the network in the initiation distinguishing process.

Any communications quality data that is representative of the radio performance for a radio channel between a user equipment and a base station and/or representative for the communication service used for this connection can be used by the present invention. Typical, non-limiting, examples of quality data that can be used according to the invention includes SNR (Signal to Noise Ratio), SIR (Signal to Interference Ratio), BLER (Block Error Ratio), BER (Bit Error Ratio) and BEP (Bit Error Probability). Another example of quality measure applicable according to the invention is when the user equipment or base station determines a difference between its current transmission power level and its maximum power level for the current service and associated radio channel. The smaller this difference is, the poorer the present radio conditions are. Alternatively, another quantity derived from the power levels, e.g. a ratio of the current transmission power level and the maximum power level for the user equipment or base station, can be used according to the invention.

Furthermore, it is anticipated by the invention that for certain quality types a high measure corresponds to a poor quality. In such a case, the network initiates a service downgrade if the estimated quality measure exceeds the downgrade threshold and initiates an upgrade if the quality falls below the upgrade threshold.

As was briefly discussed above, the service change of the invention can also be applied to situations where more than one alternative service is suggested. For example, assume that the current communications service is the primary service, i.e. the most preferred service selected by a user participating in the communications session. However, during the session, the radio conditions deteriorate so that the network will no longer be able to provide this demanding service. The network then initiates a service downgrade to a first alternative service (if this is less demanding than the primary service). The communication then continues (without any interruption) with this first alternative service. If the radio conditions continue to get worse, as determined based on the obtained quality data, the network can initiate a new service downgrade to a second alternative service, and so on. Similarly, if the radio conditions improve, the network may (possibly step-by-step) initiate service upgradings to more preferred alternative services and possibly even back to the primary service.

Each such communications service (primary and alternative services) is then preferably associated with at least one threshold to use together with quality data for determining whether to perform a service change. In order to prevent a pin-point effect with alternating service downgradings and upgradings some hysteresis effect may be introduced. For example, the network could be configured for not initiating a new service upgrade (downgrade) until a pre-defined period of time has elapsed since it last performed a service downgrade (upgrade). In addition, or alternatively, each communications service may be associated with a downgrade threshold and an upgrade threshold. For example, if the current service is the primary service and the estimated relevant quality measure falls below the downgrade threshold associated with the primary service, the network triggers a service downgrade to an alternative service. However, if the radio conditions subsequently improve, a service upgrade back to the primary service will not be initiated even though the quality exceeds the mentioned downgrade threshold. Thus, the network will not initiate this service upgrade until the quality exceeds the upgrade threshold, where the upgrade threshold is larger than the downgrade threshold.

The threshold values could be fixed and used by the network through its continuing operation. Alternatively, adjustable threshold values could be employed. In such a case, the network may change a threshold value based on input data and/or measurements of the overall radio situation in the system or some other suitable parameters.

It can be noted that the service management and change mechanism according to the present invention can be applied for two-party services, i.e. two communicating units participating in a communications session.

However, the invention is not limited thereto but could also be applied to multi-party services, e.g. conference calls with more than two participating units.

It can also be noted that some communications services may be coupled, so that when a service change affects such a service also the coupled or associated services may have to be updated. However, this can simply be solved by defining a set of services as another (single) service.

The primary service is typically an enhanced service, whereas the alternative services are more traditional communications services and are, typically, less demanding for the communications network and may have less stringent radio quality requirements. For example, a typical enhanced service could be a multimedia service, including UDI (Unrestricted Digital Information)/RDI (Restricted Digital Information) multimedia service, video telephony call service, push-to-talk service, VoIP (voice over IP) service. The alternative service can, in these cases, be a traditional speech service. Furthermore, if the enhanced service is a streaming service, providing data packets in “real-time” to the user equipment, a typical alternative service is a regular data download service, i.e. not in “real-time”. Another example according to the invention is a wideband voice service as a primary service with an alternative service as a narrowband voice service.

Thus, although the primary service and alternative service(s) can be viewed as equivalent services they typically are two distinct types or classes of services, using different functionalities and/or protocols. For example both video telephony and speech call service provides voice (audio) communication between user equipments, but the (enhanced) video telephony service also provides video communication. Furthermore, both streaming and downloading services allow provision of data packets from a service provider (including a user equipment) to a user's user equipment, but the (enhanced) streaming service allows this data provision to be performed in, or almost, real-time.

It is anticipated by the present invention that the primary service does not have to be an enhanced service but e.g. a traditional speech call service, and that the fallback service then could be an enhanced new service, e.g. video telephony.

FIG. 3 is a flow diagram illustrating additional steps of the service management method of FIG. 2. The method starts in step S10, where the first user equipment requests to use the primary service for the communication with the second user equipment. The user equipment can include an identifier or notification of this primary service in a setup message transmitted to the communication network during the communications setup procedure. The network then preferably stores this identifier of the primary service. In a next step S11, identifiers or notifications of one or more alternative services are provided to the network. These alternative service identifiers are preferably also stored in the network. The method then continues to step S1 of FIG. 2.

In an embodiment of the invention, the user of the first user equipment also selects the alternative service(s). In such a case, the identifier(s) of the alternative service(s) may be included in the same setup message or in another message transmitted to the network during the session setup. Alternatively, the user of the second user equipment can select and add an alternative service during the session setup procedure. In addition, both the first and second communications unit could notify the network of an alternative service adding during the ongoing communications session. It could also be possible that one of the user equipments (preferably the first user equipment, which initiated the communications session and selected the primary service), may inform the network of a change of the primary service. In other words, a former alternative service or a new service should be interpreted by the network as the primary and most preferred service. The former primary service could then be viewed as an alternative service.

In another embodiment of the invention, the first user equipment only provides the primary service in the setup message. In such a case, the network obtains the alternative service(s) elsewhere. For example, the HLR (Home Location Register) of the network operator, with which the user of the first user equipment has a service agreement (typically manifested in a SIM (Subscriber Identity Module)), can store user service profiles of its users. The user profile then specifies which alternative service(s) that can be used for different primary services. The user may have created this profile when signing the service agreement with the operator. Upon reception of the message with the primary service, the network then obtains suitable alternative services from this user profile based on the primary service. As an alternative, or as a combination, the network could store a default list of typical alternative services for primary services. In some cases, the choice of alternative service is rather obvious for certain primary services. For example, in the case the primary service is a video telephony call service a typical alternative service is a traditional speech call service. The network could then obtain information of the alternative service(s) to use from this default list.

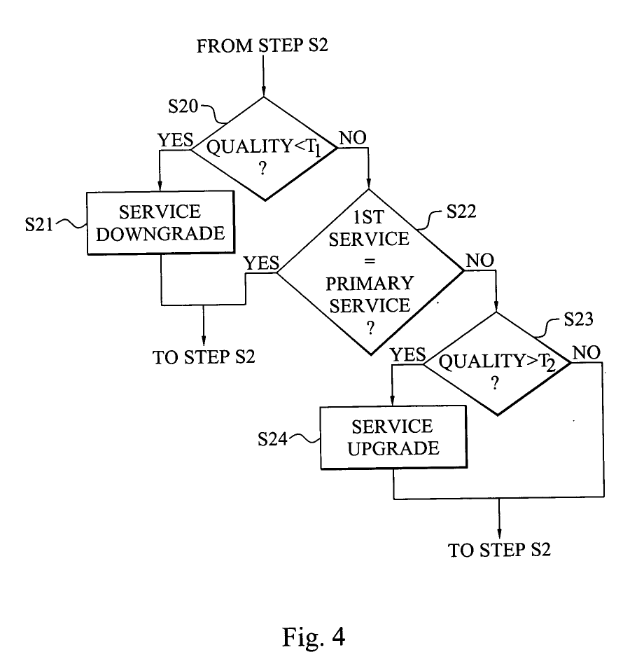

FIG. 4 is a flow diagram illustrating an embodiment of the service change initiating step of FIG. 3. The method continues from step S2 of FIG. 3. In a next step S20, it is determined whether the communications quality for the first service and its associated RB is below a downgrade threshold Ti. If this is the case, the network initiates a service downgrade in step S21 to the alternative service. The session is then continued with the second service and the method then continues to step S2 of FIG. 3.

However, if the quality exceeds the threshold Ti in step S20, the network investigates whether the current first service is the primary service selected by one of the users participating in the communications session. If the first service is the primary service, the session is continued using this most preferred service. The method continues to step S2 of FIG. 2. If the first service is not the primary service but the alternative service, the network investigates in step S23 whether a service upgrade to the primary service is possible. Thus, if the quality level exceeds an upgrade threshold T₂, the network initiates a service upgrade in step S24 to the primary service. The communication between the user equipments is then conducted using this primary service. Thereafter, or if the quality does not exceed the upgrade threshold T₂ the method continues to step S2 of FIG. 3.

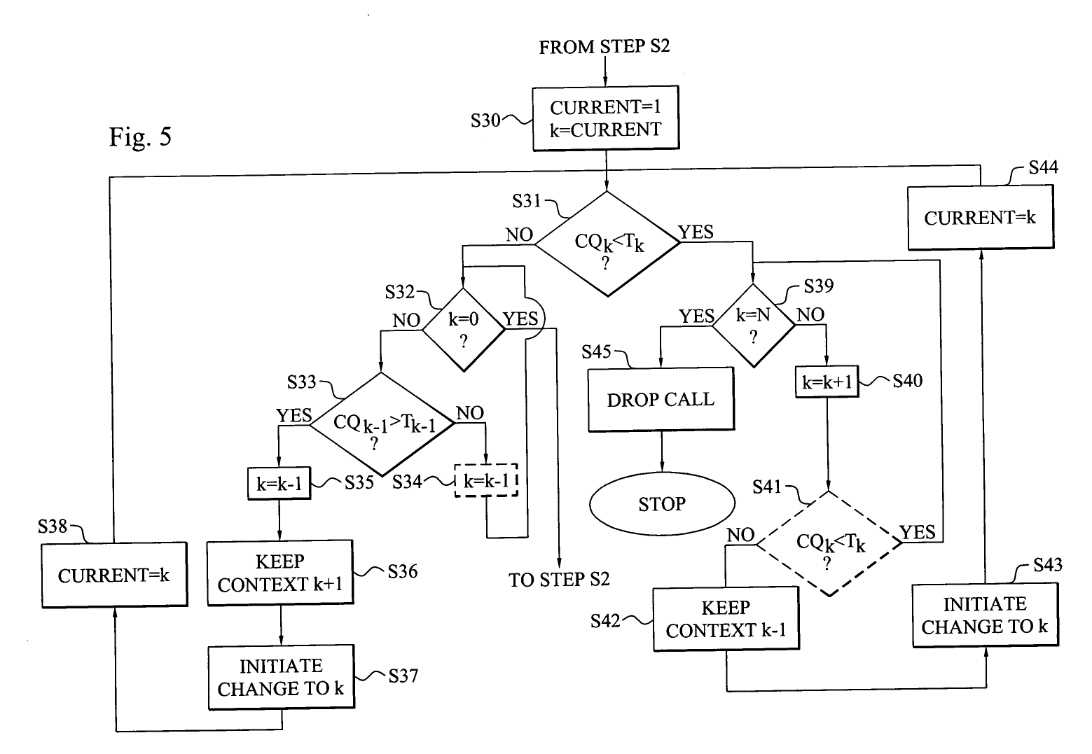

FIG. 5 is a flow diagram of another embodiment of the service change initiating step of FIG. 3 applicable for the case with multiple alternative services. In this figure, the available communications services (primary and alternative services) are identified with a service number 0, 1, . . . , N, where N is an integer larger than one. The number zero represents the primary service, one represents the most preferred service and N represents the least preferred alternative service. For exemplifying reasons it is assumed that the current communications service in the communications session between the participating user equipments is the most preferred alternative service.

The method continues from step S2 of FIG. 3. In a next step S30, a notification of the current service is stored in the network, represented by setting the current counter equal to one (i.e. identify the most preferred alternative service). In addition, a service counter k is set to the value of the current counter. In a next step S31, the network determines whether the communication quality for the service k (and its associated RBs) is below an associated downgrade threshold Tk. If the quality is not below the threshold Tk, it is determined whether k=0 in step S32, i.e. whether the current service is the primary service. In such a case, the communication continues with this primary service and the method continues to step S2 of FIG. 3. However, if k is not zero, step S33 investigates whether the communications quality of the service k-1 (and its associated RBs) exceeds an upgrade threshold Tk-1. If not, in the next step S34 the service counter is stepped down by one (k=k-1) and the method return to step S32. Thus, the loop of steps S32, S33 and S34 is used to stepwise go through the remaining more preferred services. In other words, these steps S32 to S34 investigates whether an upgrade to any of the services with a lower representative number than the current communications service can be performed. The connection between the steps S33 and S32 via S34 is only required in the case where the primary service and the alternative services are not listed in falling quality requirement order. Thus, if the (minimum) communications quality requirements for a service number j is less stringent than for a service number j-1, j=1, . . . , N, step S34 can be omitted. In such a case, if the quality of service k-1 does not exceed the threshold Tk-1 in step S33, the method could continue to step S2 of FIG. 3.

However, if the quality of the communications service k-i exceeds its upgrade threshold Tk-1 in step S33, a service upgrade could be initiated by the network and the service counter k is reduced by one in step S35.

In order to speed up a possible re-establishment of the current service (i.e. service k+1) the current communications application is put on hold, similar to as if there is a (long) link disturbance. In addition, the negotiated context is maintained or stored in step S36. Thus, if a subsequent service downgrade back to this current service would have to be performed during the communications session, the held communications application is resumed using the previously negotiated and kept context. This will allow a much faster, service re-establishment than if the context would have to be anew negotiated between the user equipments and the network. This is especially advantageous for certain communications services and applications having long round trip times and session establishment times, e.g. video telephony. Other solutions that will speed up a service change and/or re-establishment can be used according to the present invention. For example, during a service change, a pre-defined (simple) default configuration is used by the user equipment. Such a default configuration is then only used for starting the service change. Thereafter, the user equipment switches to a configuration associated with the new communications service. The default configuration should then be simpler than the corresponding ordinary service configuration in order to speed up the service change.

In the next step S37, the network initiates the service change to this new service k. A notification of this current service is then stored in the network, represented by setting the current counter equal to k in step S38. The method then continues to step S31.

If step S31 determines that the current communications quality is below the downgrade threshold Tk, it is determined in a next step S39 whether the current service is the last and least preferred alternative service, i.e. k=N. If this is the case, it might be possible that present radio conditions are so poor that no communications service could be supported and the call has to be dropped and the session is ended in step S45. However, in cases where the least preferred alternative service is not the communications service with the lowest radio quality requirements, a loop that identifies the service with the lowest quality requirements could be added to FIG. 5. However, if the present quality still is below its associated threshold, the call may have to be dropped, otherwise a service downgrade to that service could be performed.

If k is not equal to N in step S39, the service counter is increased by one in step S40. The next step S41, investigates whether the radio conditions could support this new service k. If no, the loop of step S39, S40 and S41 is repeated until such a communications service is found or the end of the available service list is reached. In cases where the communications services are listed in falling radio quality requirement order, as was discussed above, step S41 can be omitted. The method then continues directly from step S40 to step S42. In this step S42, the context of the current service (k-1) is kept similar to step S36. The network then initiates as service downgrade to the new service k in step S43. The current counter is then set to the value of k in step S44 in order to store a notification of the current communications service. The method then continues to step S31.

In a particular embodiment of the invention the thresholds employed in steps S31, S41 and step S33 differ. Thus, steps S31 and S41 employ downgrade thresholds, whereas step S33 uses upgrade thresholds.

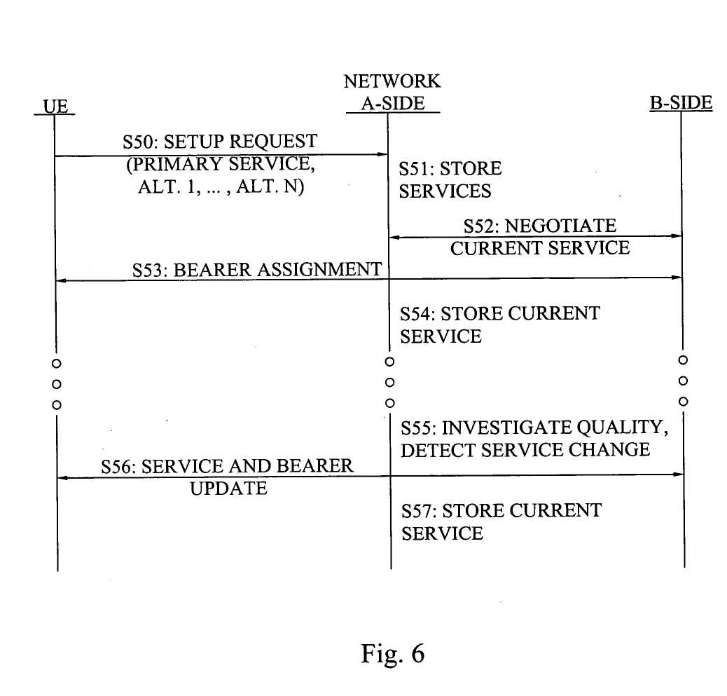

FIG. 6 schematically illustrates a signal diagram of the management of alternative communications services according to the present invention. In FIG. 6, network A-side refers to the originating communications network (core network and radio access network), to which the (originating) user equipment (UE) is connected. B-side, typically, refers to the terminating user equipment, to which the originating UE wants to communicate, and its connected (terminating) network.

The signaling preferably starts with the user equipment transmitting a setup request message to its network (step S50). This messages indicates that the user equipment wants to communicate with another user equipment (terminating user equipment) and with which service such communication preferably is conducted. This service is in the present description referred to a primary or preferred service. For example, in the SETUP message the repeat indicator is set to “support of service change and fallback” together with a bearer capability (BC) information element (1E) specifying the primary service.

In a first embodiment, the setup message also comprises one or several alternative services, to use if the primary service somehow is unavailable.

Such fallback services are less preferred (from the point of view of the user of the user equipment), but still acceptable services that can be used in the case the preferred primary service is unavailable. In such a case, in addition to the primary service BC-IE, one or several alternative BC-IEs is provided in the message. Sending setup messages comprising information of primary and fallback services is further described in section 4.2.1 to 4.2.3 of [1], the teaching of which is hereby incorporated by reference.

In another embodiment of the invention, the user equipment only provides the primary service in the setup message and the network obtains the alternative service(s) elsewhere, for example from a user profile in the HLR or from a default list, which was discussed in the foregoing.

The network then stores or holds information of the primary service (from the user equipment) and the selected alternative service(s) (from the user equipment, HLR and/or default list) (step S51). This service information is typically stored in the core network portion of the communications network, such as in a MSC (Mobile Switching Center), SGSN (Serving GPRS (General Packet Radio Service) Support Node) and/or GGSN (Gateway GPRS Support Node). In addition, the network stores information of which provided service that is the primary service, i.e. is the preferred service requested by the user. Thereafter the network negotiates currently available and possible services and bearers with the B-side (terminating MSC and user equipment) (step S52). In this negotiation, the terminating user equipment's functionalities, delay characteristics, etc., are taken into account. More information of service negotiation can be found in section 4.3.1 to 4.3.4 of [1], the teaching of which is hereby incorporated by reference.

Once the negotiation is complete, the negotiated channel or radio access bearer and service are assigned (step S53). Information of the selected service from the negotiation is then stored in the network (step S54).

The two user equipments can now employ the negotiated service and perform communication based on the service and assigned bearer.

The network and/or user equpment(s) investigate the conditions of the selected bearer and the radio performance, preferably of the selected bearer but also of bearers of the other services presently not used (step S55). In a typical example, the radio access network and/or user equipments perform the monitoring of the radio performance (preferably in UTRAN (UMTS Radio Access Network)), even if the user equipments temporarily operates in GSM due to an earlier loss of UMTS coverage) and informs the core network portion of the communications system of the radio performance. If the channel or bearer quality is below (above) a downgrade (upgrade) threshold value, the network performs a service downgrade (upgrade). In such a case, one of the alternative services (primary service or more preferred alternative service) and suitable bearer thereof is assigned and updated (step S56). If several alternative services are available the network preferably chooses the most preferred of these services.

If the current service is “unsuitable” for “handover” to another RAT (Radio Access Technology), the core network could first trigger a service change and then handover (possibly handover+service change if the mobile is in GSM).

Once the new service and bearer are updated the network stores information of this (new) current service (step S57).

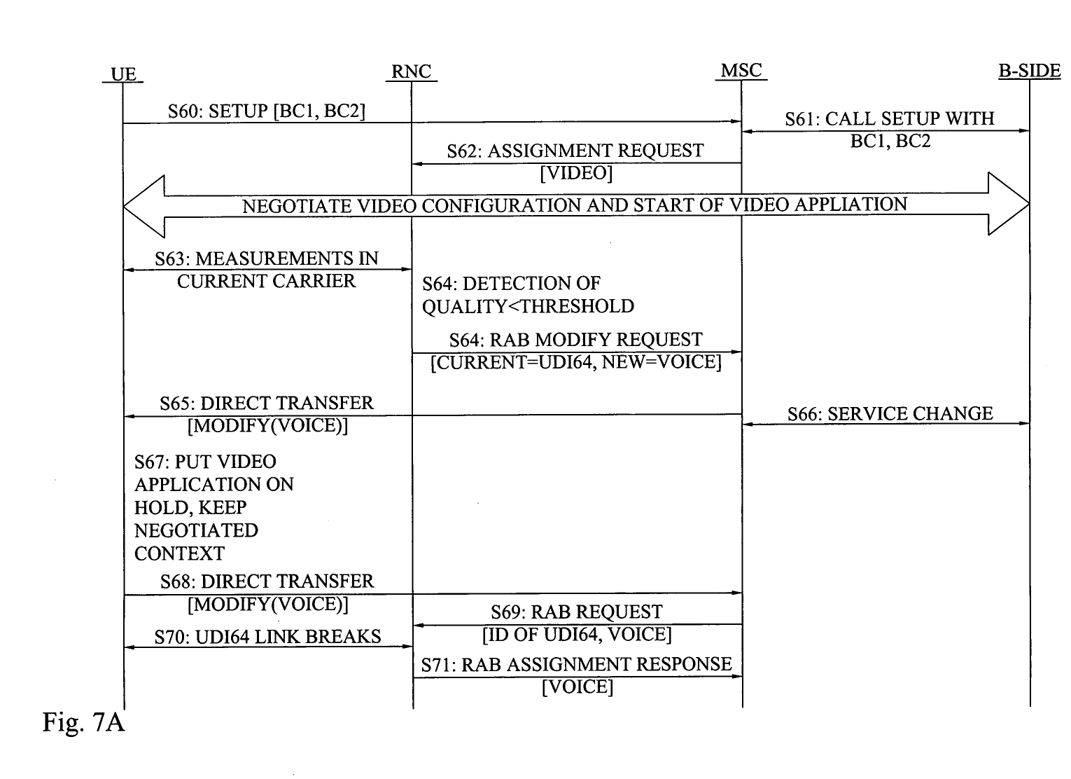

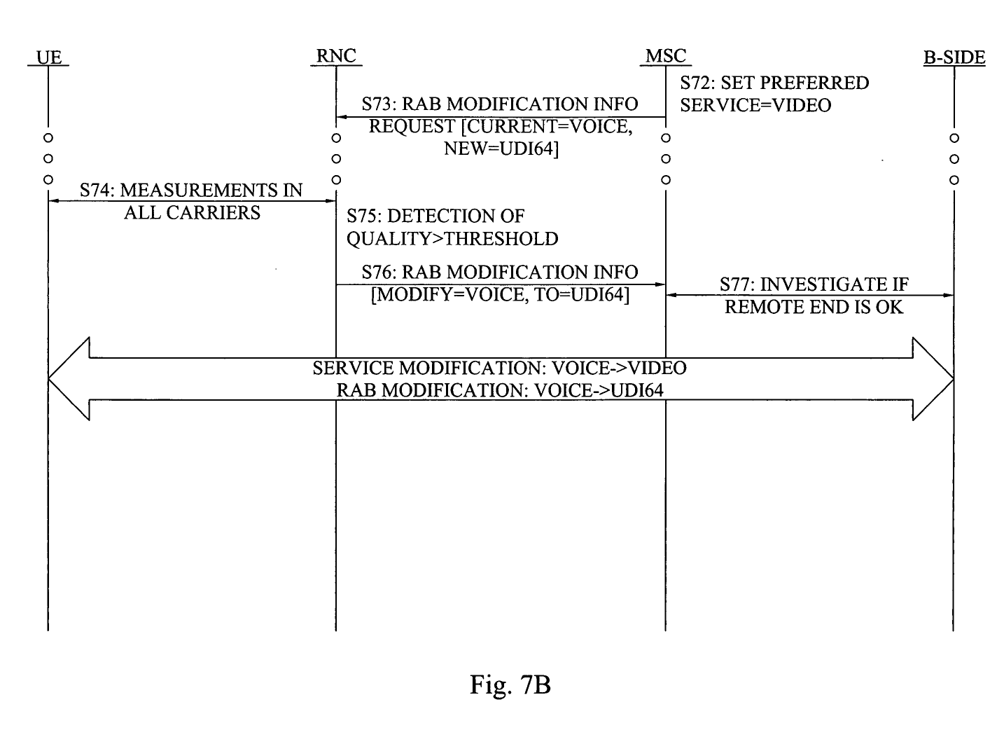

The invention will now be exemplified with the primary service as video telephony on UDI164 RBs and the alternative service as voice telephony with reference to FIGS. 7A and 7B. In these figures, RNC refers to radio network controller.

The user equipment sends a setup message using the repeat indicator value “support of service change and fallback” together with two BC-IEs; BC1 (video telephony, UDI64) and BC2 (voice) to its connected MSC (step S60). A regular call setup procedure is performed but with two BC (B1 and BC2), including negotiation with MSC-A and the MSC of “B-side” (step S61). An assignment request specifying BC1, i.e. video, is then transmitted to RNC (step S62). The rest of the signaling in this setup procedure is according prior art technique and is not discussed further herein.

A negotiation of configuration and start of applications is then performed, resulting in the 3G-324.M codec of video telephony. The video telephony call can then be conducted between the two user equipments.

During the call, measurements in the current carrier are performed, preferably without Compressed Mode (step S63). If, during such measurements, the quality drops below a pre-determined threshold value (step S64), a change of RB and services is started. The RNC sends a RAB modify request message to the MSC with the RABtoChange parameter set to UDI64 (current bearer used for video telephony), ChangeTo set to voice and possible with new Cause Value set to coverage loss (step S64).

A service change procedure, including UE, transcoder/user plane, etc., is then performed based on the request message (step S66). This procedure is described in more detail in [2] and [3], the teaching of which is hereby incorporated by reference.

A direct transfer message with modify set to speech is then sent to the application in the user equipment (step S65). Upon reception, the 3G-324.M application is put on hold, similar to as if there is a (long) link disturbance (step S67). The negotiated context is maintained. When the modification is completed, a response direct transfer message with modify complete set to speech is transmitted from the user equipment to the MSC (step S68).

In cases handover is time-critical, the MSC preferably should not wait for the response from the terminating (B) side. Thus, a RAB assignment request is preferably transmitted to the RNC with RAB ID for UDI64; voice and possible Service handover set to GSM (step S69). The UDI64 link is then broken (step S70) and a RAB assignment response including voice is returned (step S71). The core network (MSC) sets the desired mode or service to UDI64 (primary service) (step S72). A RAB modification information request is then transmitted to the RNC identifying the RAB to be modified=voice and that the RB should be modified to UDI64, Delay/Hysteresis, Reporting Method=event (step S73). The appropriate compressed mode (SF/2) is then activated. Measurement order and reports on all frequencies and radio access technologies are then obtained.

The user equipments now conduct traditional speech (alternative service). Similar to step S63, signal quality measurements are performed by the user equipment(s) and/or network, preferably on all relevant carriers, where possible (step S74). If the conditions change, as determined by the network in the measurements and reports (step S75), a RAB modification information message is then sent to the MSC, indicating the RB to be modified=voice and modified to UDI164, possible Delay/Hysteresis and Result=possible (step S76).

The core network portion of the originating network (A-side) then checks if the user equipment of the “B-side” also has sent OK to change message (step S77). In such a case the service is modified from voice to video and the RB is modified from voice to UDI64, similar to above.

The 3G-324.M application resumes using the previous negotiated context, since the “Telephony part” has not informed that the old call has ceased. The two user equipments now use UDI64 RB to conduct video telephony.

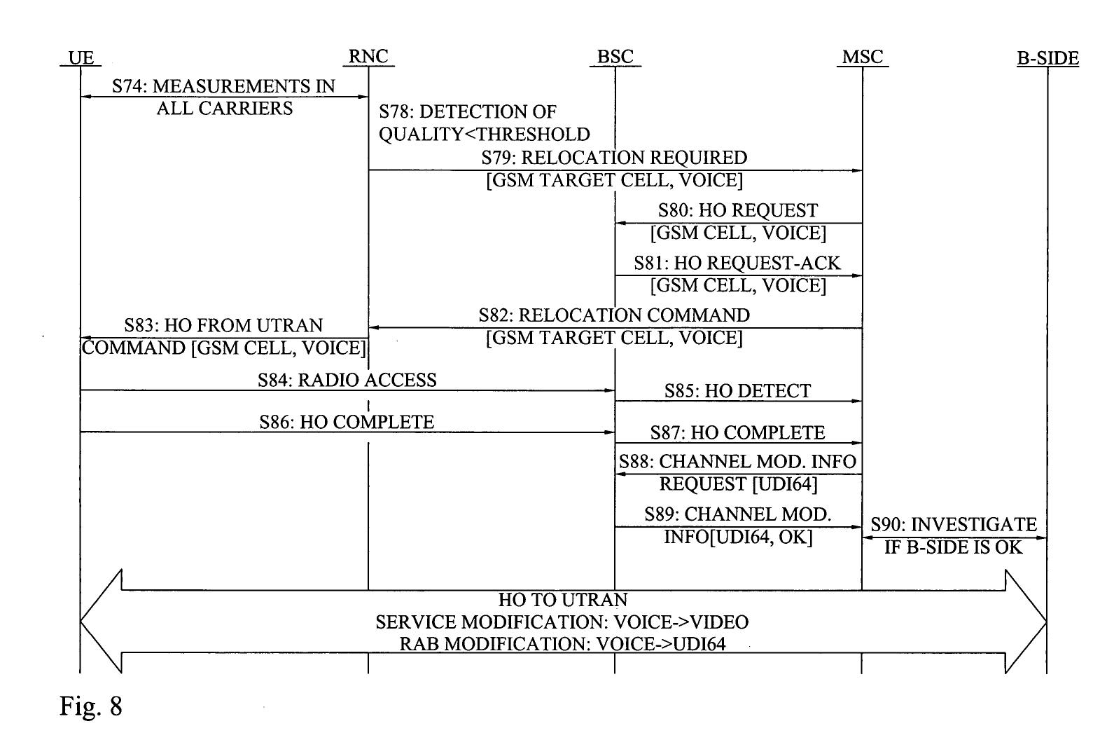

During the UMTS part of the session of FIGS. 7A and 7B, the call may be handed over to GSM. In such a case the signaling sequence is as illustrated in the example of FIG. 8, which is a continuation of the signaling in FIG. 7A. In this FIG. 8, BSC represents base station controller. The signaling is similar to FIG. 7B until the network detects that the radio conditions in UTRAN for the voice service has deteriorated so much so that a handover from the current UMTS cell to a GSM cell is required for the user equipment (step S78). If required, the RNC then transmits a relocation required message to the MSC indicating the desired GSM target cell and that the service is voice (step S79). The MSC transmits a handover (HO) request to the BSC accompanied by the GSM target cell from RNC and indicating voice service (step S80). A HO request acknowledgement (ACK) is returned including the same parameters as the HO request (step S81). A relocation command is then sent to the RNC (step S82), which sends a command to the user equipment commanding handover from UTRAN to the GSM target cell included in the command (step S83). The user equipment then performs a radio access to the BSC (step S84), which transmits a notification to the MSC that the handover is detected (step S85). The user equipment also sends a HO completed message to the BSC (step S86), which sends a similar message to the MSC (step S87). The user equipment now uses a speech bearer in GSM. Since the currently used speech service is not the primary service the MSC sends a channel modification information request pointing out the preferred RB, i.e. UDI64 (step S88). The BSC returns the modification information if UDI64 is OK (step S89). The core network portion of the originating network (A-side) then checks if the user equipment of the “B-side” also has sent OK to change message (step S90). A subsequent handover back to UTRAN can then be performed followed by a possible service change back to video telephony. This signaling is similar to FIG. 7B and is not described in more detail here.

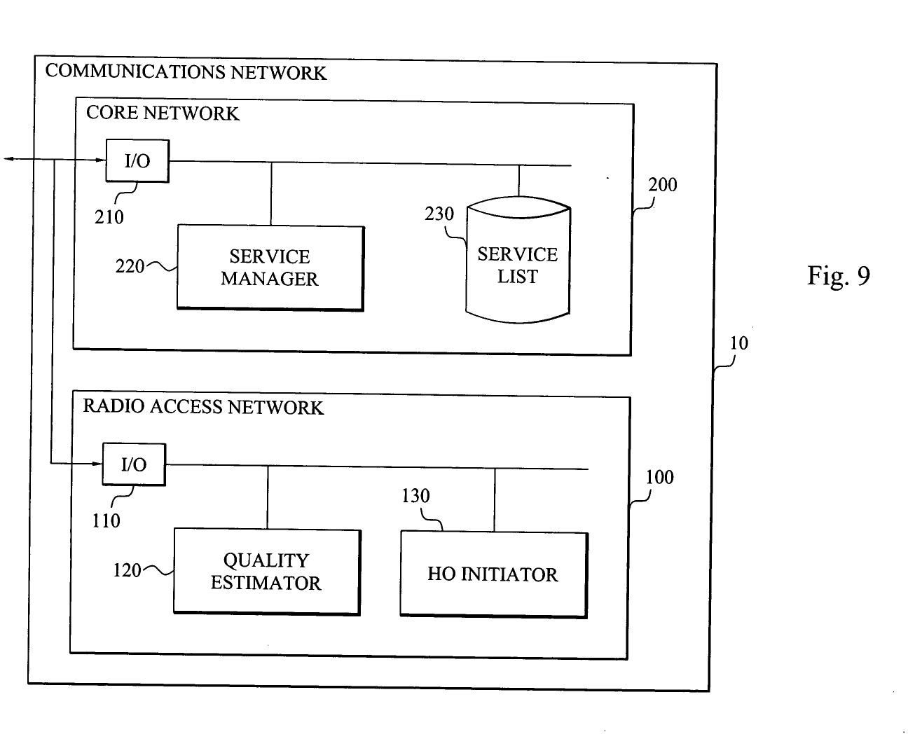

FIG. 9 is a schematic block diagram of a communications network 10 according to the present invention. The communications network typically includes a core network portion 200 and a radio access network portion 100. It is anticipated by the invention, that in practice the network 10 can include multiple core networks 200 and/or multiple radio access networks 100.

Starting with the core network 200, this network portion 200 includes a unit or means, represented by a general input and output (I/O) unit 210), for conducting communication with external units in the communications system, including the radio access network 100 and other core network portions. This I/O unit 210 is in particular adapted for transmitting service change commands to the radio access network 100 and further to the involved user equipment and possibly to other core networks. In addition, the I/O unit 210 receives notifications of primary and alternative services to use for a communications session between user equipments. The I/O unit 210 receives communications quality data, e.g. originating from the access network 100 and/or user equipment, to use in the determination whether to initiate a service change.

The core network 200 further includes a service manager 220 that is implemented for initiating service changes based on input communications quality data. The service manager 220 also manages information of the requested primary and alternative services for a communications session, for example by storing identifiers of the primary, alternative and preferably the currently employed communications service in an associated database or memory 230. Instead of storing identifiers of the primary and/or alternative services, the manager 220 could retrieve such identifiers from the user service profiles or default service list. Alternatively, the manager 220 could, before initiating a service change, request identifiers of the primary and/or alternative services from the relevant user equipment.

This memory 230, or another storage unit in the communications network 10, preferably stores user service profiles and/or default service profiles. These service profiles can then be accessed by the service manager upon reception of a primary service request from a user equipment to determine suitable alternative services to use in connection with the primary service. The user profiles could alternatively be stored at the HLR managing the user data for a particular user equipment and its user.

This means that the service manger 220 can be implemented for only employing any alternative services notified by one of the session participating users. Alternatively, or in addition, the manager 220 can add suitable alternative from either users' user profile and/or from the default list in the memory 230. Also the manager 220 could use a prioritized alternative service management. For example, if one of the user equipments notifies the manager 220 of at least one alternative service to use in connection with the requested primary service, the manager 220 will not add any alternative service. However, if no user requests any alternative service, the manager 220 firstly investigates whether any of the users have generated and stored a user service profile in the memory 230. In such a case, the manager 220 retrieves information of suitable alternative service from such profiles. If the users' have not generated any user service profiles, or the current primary service and associated alternative services are not found in the profiles, the managing unit 220 will use the default service list as a service information basis.

Correspondingly to the core network 200, the radio access network 100 includes an I/O unit 110 for conduction communication with external units, e.g. core network 200, other access networks, base stations and user equipments. This I/O unit 110 is in particular adapted for receiving service change commands from the core network 200 and for forwarding them to the relevant user equipments. Furthermore, the I/O unit 110 could receive communications quality reports from the user equipments.

A quality estimator 120 is provided in the radio access network 100 for processing communications quality data and preferably for performing quality measurements. Thus, this estimating unit 120 could itself perform quality estimations of a current (uplink) channel and preferably also for other radio channels. Alternatively, it requests some other units in the network for performing quality measurements and reporting them to the estimator 120. The estimator 120 preferably processes this network-based quality data with any quality data received from the user equipments in order to get as an accurate estimation of the current radio conditions for the different radio channels as possible. Once the quality data has been generated the estimator 120 forwards it, via the I/O units 110, 210, to the service manager 220 in the core network.

A handover initiator 130 is implemented in the radio access network 100, or in the core network 200, for generating a handover command when, due to a service change and/or a deterioration of the radio conditions, as determined by the estimator 120, a handover to another RAT is required.

The units 110 to 130 and 210 to 220 of the communications network 10 may be provided as software, hardware or a combination thereof. It is anticipated by the invention that some of the units and the functionalities discussed above and disclosed in FIG. 9 as being implemented in the core network 200 (radio access network 100) can also, or in addition, be implemented in the radio access network 100 (core network 200). The units 210 to 230 may be implemented together in the core network 200.

Alternatively, the units 210 to 230 may be implemented in different network nodes. For example, the units can be implemented in MSC, GGSN, SGSN and/or HLR nodes. Correspondingly, the units 110 to 130 may be implemented together in the radio access network 100. Alternatively, the units 110 to 230 may be implemented in different network nodes. For example, the units can be implemented in different BSC, RNC, BSS (base station system) and/or base station nodes.

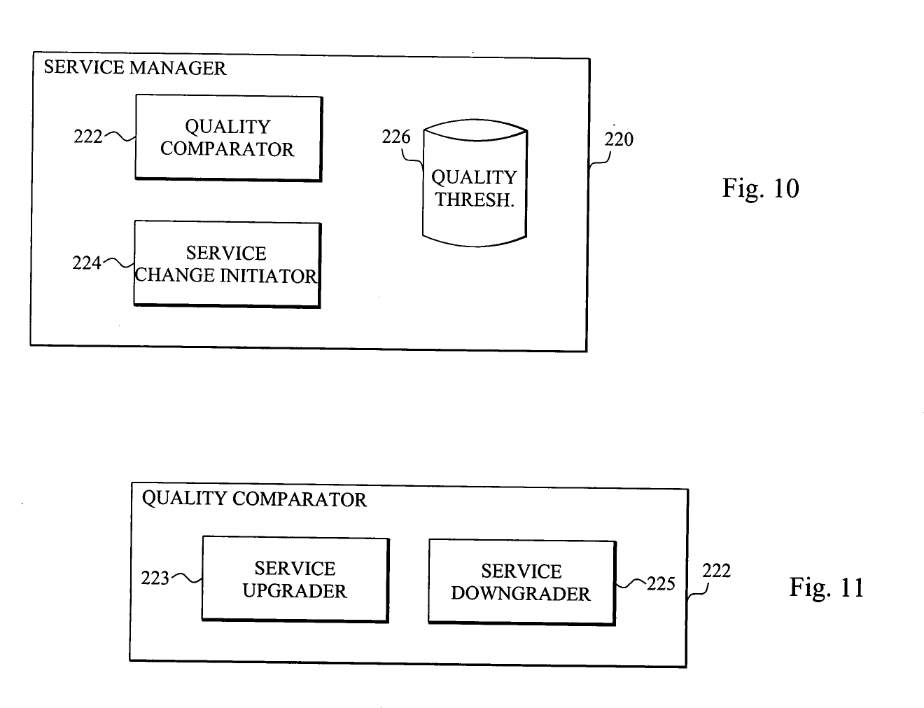

FIG. 10 is a schematic block diagram illustrating an embodiment of the service manager 220 in more detail. The service manager 220 includes a quality comparator 222 that receives the communications quality data from the radio access network. This comparing unit 222 then processes this quality data for determining whether to generate a service change command. In this processing the comparator 222 preferably compares the received quality data with a quality threshold, e.g. provided from an associated threshold storage 226, or elsewhere, e.g. stored in the service memory discussed above in connection with FIG. 9. Based on the quality value and the relevant threshold value, the comparator 222 generates a notification of a possible service upgrade, a service downgrade or no such notification. Thus, if the current radio conditions are poor, as determined when the received quality data is below a downgrade threshold, a service downgrade notification is generated. Correspondingly, if the radio conditions allow it and the current communications service is not the primary service, the comparator 222 will generate a service upgrade notification.

The generated service change notification is then forwarded from the quality comparator 222 to a service change initiator 224. This initiating unit 224 then generates a service (upgrade or downgrade) change command that will be communicated to the effected units, including the user equipments and possibly the radio access network(s). These commands then preferably specify the new service, to which a service change is to be performed. In addition, the command could include an identifier of the current service, e.g. as retrieved from the service list memory of FIG. 9.

The threshold memory 226 preferably holds different threshold for different services. A given threshold should then represent the radio quality requirements for its associated communications service. In addition, a communications service could be associated with a service upgrade threshold and a service downgrade threshold. The threshold values could be fixed or be changed in response to a threshold update command generated from some external unit, e.g. the service manager 220.

The units 222 and 224 of the service manager 220 may be provided as software, hardware or a combination thereof. The units 222 to 226 may be implemented together in the manager 220. Alternatively, a distributed implementation is also possible with some of the units provided elsewhere in the core network or radio network portion of the communications network.

FIG. 11 is a schematic block diagram of an embodiment of the quality comparator 222 according to the invention. The comparator includes a service upgrader 223 that generates a service upgrade notification to be forwarded to the service change initiator in cases where the current radio conditions allows a service change to a more preferred communications service. Correspondingly, a service downgrader 225 generates a service downgrade notification if the radio conditions are so poor that a service downgrade to a less quality demanding service is required. The respective upgrading unit 223 and downgrading unit 225 basis its notification generation process on a comparison between the reported quality data and at least one threshold from the associated threshold storage.

The units 223 and 225 of the quality comparator 222 may be provided as software, hardware or a combination thereof. The units 223 and 225 may be implemented together in the comparator 222. Alternatively, a distributed implementation is also possible with some of the units provided elsewhere in the service manager.

In the foregoing description, the alternative service management of the invention has mainly be described with reference of performing a service change for a communications session between two or more user equipment. However, the present invention is not limited thereto. Also other communicating units that can conduct communication using different forms of services can be used. For example, a first user might want to obtain video data from a service provider. The primary service could then be data streaming in real-time or at least near-real-time. A typical alternative service is then a traditional data downloading service. Thus, the invention can be applied to communication with any communicating unit in a communications system.

Furthermore, the service change has been described as being initiated based on the communications network based on communications quality data. This expression communications network also includes different user-servers that can monitor operation of its associated or connected user equipments.

It is anticipated by the present invention that the different embodiments described above and disclosed in the FIGS. 1 to 11 can be combined.

It will be understood a person skilled in the art that various modifications and changes may be made to the present invention without departure from the scope thereof, which is defined by the appended claims.

### REFERENCES

[1] 3GPP TS 23.172 v5.1.0, 3^{rd} Generation Partnership Project; Technical Specification Group Core Network; Technical realization of Circuit Switched (CS) multimedia service UDI/RDI fallback and service modification; Stage 2, December 2002.
[2] 3GPP TSG-CN WG3 Meeting #25, Tdoc N3-020817, Inter-MSC Relocation for SCUDIF, Miami, USA, 23^{rd}-27^{th} September, 2002.
[3] 3GPP TSG-CN WG3 Meeting #28, Tdoc N#-030437, Callflows for Service change during the active state, San Diego, USA, 19^{th}-23^{rd} March, 2003.

1. A communications service management method in a communications system comprising a communications network, a first communicating unit and a second communicating unit, said method comprising, during an ongoing communication between said first communicating unit and said second communicating unit using a first communications service, said network initiating a service change from said first communications service to a second communications service based on an estimated communications quality for at least one of said first and second communications service.

2. The method according to claim 1, further comprising the steps of:
comparing said estimated communications quality with a minimum required quality; and
said network initiating said service change based on said comparison.

3. The method according to claim 2, further comprising the steps of:
estimating said communications quality for said first communications service; and
said network initiating said service change if said estimated communication quality falls below said minimum required quality.

4. The method according to claim 2, further comprising the steps of:
estimating said communications quality for said second communications service; and
said network initiating said service change if said estimated communication quality exceeds said minimum required quality.

5. The method according to claim 1, further comprising estimating said communications quality for said first and said second communications service.

6. The method according to claim 1, further comprising the steps of:
said first communicating unit transmitting an identifier of a primary communications service to said network; and
providing an identifier of at least one alternative communications service, wherein said first and second communications services are selected from said primary communications service and said at least one alternative communications service.

7. The method according to claim 6, wherein said providing step comprises said first communicating unit transmitting said identifier of said at least one alternative communications service to said network.

8. The method according to claim 6, wherein said providing step comprises providing said identifier of said at least one alternative communications service from a user profile associated with said first communicating unit and stored in said network.

9. The method according to claim 6, wherein said providing step comprises providing said identifier of said at least one alternative communications service from a default profile stored in said network.

10. The method according to claim 1, further comprising the step of storing an identifier of a current communications service in said network.

11. The method according to claim 1, further comprising keeping a context of said first communications service in said first communicating unit after said service change to said second communications service.

12. The method according to claim 11, further comprising said first communicating unit employing said kept context for re-starting said first communications service during a subsequent network-initiated service change from said second communications service to said first communications service.

13. The method according to claim 1, further comprising the steps of:
initially employing a predefined default configuration for said first communicating unit during said service change; and
changing to a configuration associated with said second communication service.

14. The method according to claim 1, further comprising said network initiating a handover for said first communicating unit from a first radio access network in said communications system to a second radio access network if said first radio access network does not support said second communications service.

15. A communications service management system in a communications system comprising a first communicating unit and a second communicating unit conducting communication using a first communications service, said management system comprising means for initiating, during said ongoing communication, a service change from said first communications service to a second communications service based on an estimated communications quality for at least one of said first and second communications service.

16. The system according to claim 15, further comprising means for comparing said estimated communications quality with a minimum required quality and generating a service update command based on said comparison, and said initiating means is configured for initiating said service change in response to said service update command.

17. The system according to claim 16, further comprising means for receiving an estimated communications quality for said first communications service, and said comparing means is configured for generating a service downgrade command if said estimated communications quality falls below said minimum required quality.

18. The system according to claim 16, further comprising means for receiving an estimated communications quality for said second communications service, and said comparing means is configured for generating a service upgrade command if said estimated communications quality exceeds said minimum required quality.

19. The system according to claim 15, further comprising:
means for receiving an identifier of a primary communications service from said first communicating unit; and
means for providing an identifier of at least one alternative communications service, wherein said initiating means is configured for selecting said second communications service from said primary communications service and said at least one alternative service.

20. The system according to claim 19, wherein said providing means is configured for receiving said identifier of said at least one alternative communications service from said first communicating unit.

21. The system according to claim 19, wherein said providing means is configured for providing said identifier of said at least one alternative communications service from a pre-defined user profile associated with said first communicating unit.

22. The system according to claim 19, wherein said providing means is configured for providing said identifier of said at least one alternative communications service from a pre-defined default profile.

23. The system according to claim 15, further comprising means for storing an identifier of a current communications service.

24. The system according to claim 15, further comprising:
means for initially employing a predefined default configuration for said first communicating unit during said service change; and
means for changing to a configuration associated with said second communication service.

25. The system according to claim 15, further comprising means for initiating a handover for said first communicating unit from a first radio access network in said communications system to a second radio access network if said first radio access network does not support said second communications service.

26. The system according to claim 15, wherein said communications service management system is provided in a network node in said communications system.

27. A communications service management system in a communications system comprising a first communicating unit conducting communication with a second communicating unit using a first communications service, said management system comprising:
means for storing identifiers of a primary communications service selected by said first communicating unit and of at least one alternative communications service, said first communications service being selected from said primary and said at least one alternative communications service;
means for receiving an estimated communications quality for a communications service selected from said primary and said at least one alternative communications service; and
means for initiating, during said ongoing communication, a service change from said first communications service to a second communications service, selected from said primary and said at least one alternative communications service, based on said received communications quality.
